(19) United States
(12) Patent Application Publication
(10) Pub. No.: US 2004/0114367 A1
(43) Pub. Date: Jun. 17, 2004

(54) Light emitting diode light bulb

(76) Inventor: Jui-Tuan Li, Shijr City (TW)

Correspondence Address: Jui-Tuan Li, P.O. Box No.6-57, Chung-Ho, Taipei, 235, TW

(21) Appl. No.: 10/318,056

(22) Filed: Dec. 13, 2002

(51) Int. Cl. F21V 1/00

(52) U.S. Cl. 362/248; 362/240; 362/800

(57) ABSTRACT

A light emitting diode (LED) light bulb includes a lamp holder and a lamp body; wherein the light body is disposed on the top plane of the lamp holder; the present invention is characterized that the lamp body is composed by more than two circuit boards; a plurality of LED light bulbs are disposed in parallel or in tandem on each circuit board such that the light source of the LED extensively emits toward all the directions; applying the abovementioned structure accordingly, the LED light bulb saves the electricity and has a longer useful life so as to effectively save the cost.

### BACKGROUND OF THE INVENTION

1. Field of the Invention

The present invention relates to a light emitting diode (LED) light bulb, more particularly to a multi-directional and three-dimensional lamp body composed by more than two circuit boards; a plurality of LEDs disposed on the circuit boards of the lamp body provide light sources to emit at wider angles and with more brightness.

2. Description of the Prior Art

Accordingly, a conventional tungsten light bulb, as indicated in FIG. 5, has a lamp holder (a) disposed with a tungsten (b) on the top plane thereof; a transparent or non-transparent glass lamp cover (c) shields on the lamp holder (a) to form a light bulb. When using this kind of light bulb, it is necessary to use the tungsten (b) to generate light for illumination. However, the useful life of the tungsten (b) is short; once it reaches the expiration period, the tungsten (b) burns, becomes useless and has to be discarded. Furthermore, the abovementioned light bulb provides different degrees of brightness according to the wattages thereof; the higher the wattage is, the more electricity consumes and that increases the electricity cost.

Another conventional light emitting diode (LED) light bulb, as indicated in FIG. 6, has a circuit board (e) disposed with a lamp holder (d) on the top plane thereof; a plurality of LEDs are disposed on the end plane of the circuit board (e); a lamp cover (f) shields on the lamp holder (d) to form a LED light bulb. However, when in use, the light source emitted from the abovementioned light bulb merely projects the light in a mono-direction. For obtaining a diffusing light source, the conventional LED light bulb hardly achieves the excellent effect.

In view of the undesired and inconvenience of the application and structure of the conventional tungsten or LED light bulb, the inventor of the present invention researched and developed the present invention of an innovative light emitting diode light bulb.

### SUMMARY OF THE INVENTION

The primary objective of the present invention is to provide a multidirectional lamp body composed by more than two circuit boards; a plurality of light emitting diodes disposed on the circuit boards to provide a light source for emitting in a wider scope and at a wider angle; the present invention is electricity-saving and has a longer useful life; it is also capable of enhancing application period and reduce electricity cost.

To enable a further understanding of the structure and effectiveness of the present invention, the brief description of the drawings is followed by the detailed description of a preferred embodiment.

### BRIEF DESCRIPTION OF THE DRAWINGS

FIG. 1 is a pictorial drawing of an exemplary embodiment of the present invention.

FIG. 2 is a pictorial drawing of another exemplary embodiment of the present invention.

FIG. 3 is a pictorial drawing of yet another exemplary embodiment of the present invention.

FIG. 4 is a pictorial drawing of still another exemplary embodiment of the present invention.

FIG. 5 is a pictorial drawing of a conventional tungsten light bulb.

FIG. 6 is a pictorial drawing of a conventional light emitting diode light bulb.

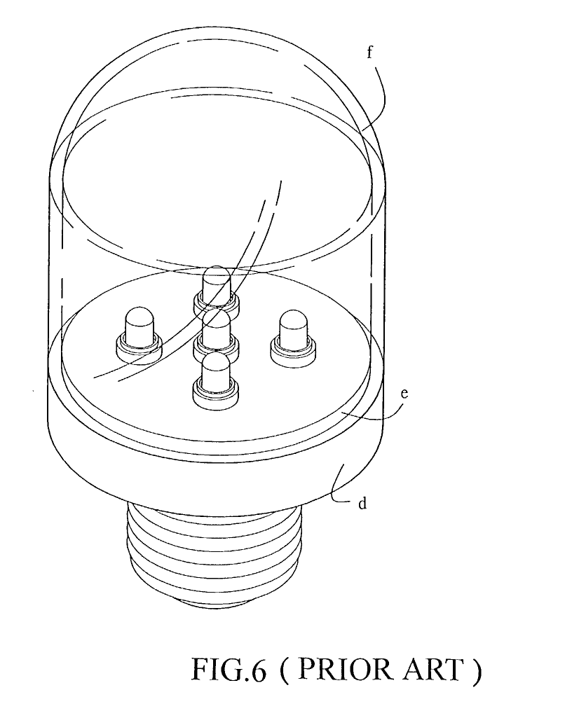

### DETAILED DESCRIPTION OF THE PREFERRED EMBODIMENTS

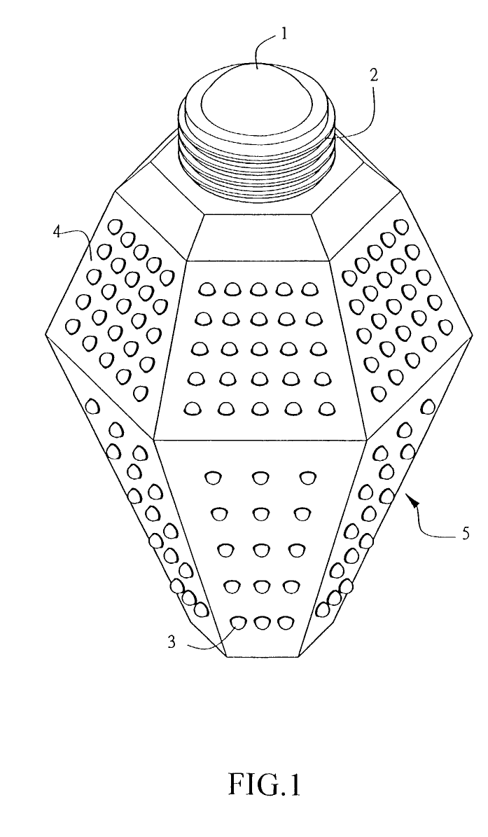

Referring to FIGS. 1, a light emitting diode (LED) light bulb comprises an electric conduction portion (1), a lamp holder (2) and a lamp body (5); one end of the electric conduction portion (1) is disposed inside a lamp tool and the other end thereof connects with the lamp holder (2); the other end of the lamp holder (2) assembles with one end of the lamp body (5). The present invention is characterized that, the lamp body (5) comprises more than two circuit boards (4) to form a multi-directional and three-dimensional shape; a plurality of LED light bulbs (3) are disposed in parallel or in tandem on each circuit board (4); the light source emitted from the LED extensively projects toward all the directions.

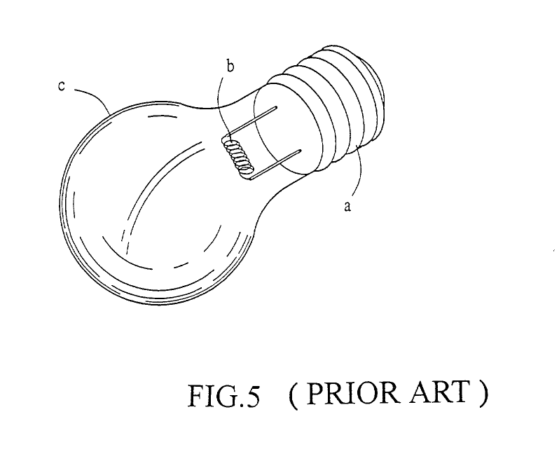

When applying the abovementioned structure accordingly, the present invention uses the electricity-saving LED (3) with a longer useful life as the light source; therefore the product of the present invention has a longer useful life and the advantage of being able to save the energy. Furthermore, the lamp body (5) of the present invention is of a multi-directional and three-dimensional shape capable of emitting light toward all the directions to have an extensive illuminating scope so as to substitute a conventional tungsten light bulb, as shown in FIG. 5. In addition, for increasing the brightness of the lamp body (5), it is merely necessary to increase the number of the LED (3). The present invention can be applied for manufacturing an art lamp such that the LED light bulb (3) creates specially oriented or extensive illumination effect.

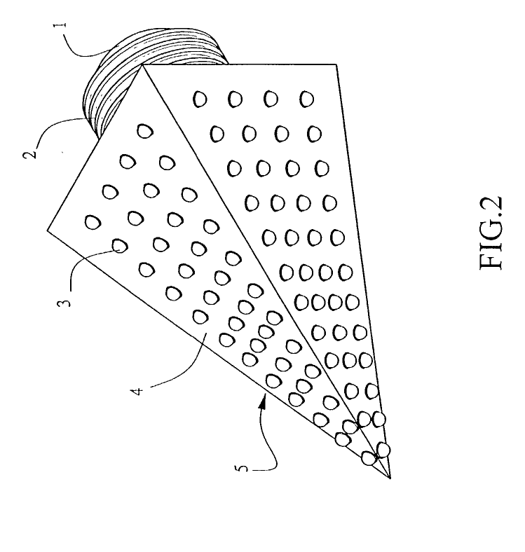

Referring to FIGS. 2 to 4, the shape of the lamp body (5) of the present invention is flexible for any making composition and variation. The abovementioned two exemplary embodiments allow the light source to emit toward a specified scope and direction. The external style of the lamp body (5) of the present invention is flexible for any making composition and variation. Therefore, the configuration thereof is not limited to the abovementioned. The exemplary embodiments provided here are only for reference purpose.

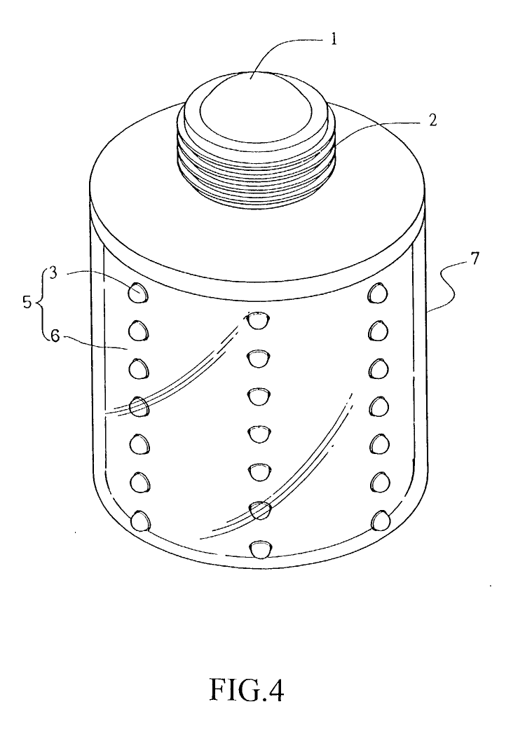

Furthermore, as indicated in the exemplary embodiment in FIG. 4, the circuit board inside the lamp body (5) is a soft circuit board (6); therefore, the lamp body (5) is formed into a three-dimensional shape with curved planes by bending one or more than one soft circuit board (6) to achieve the expected objective.

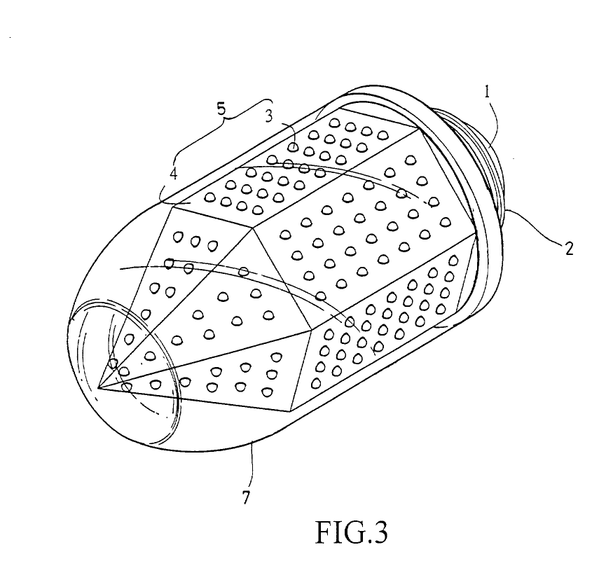

Referring to FIGS. 3 and 4, when applying the present invention of a LED light bulb, a transparent or non-transparent lamp cover (7) is disposed at the upper aspect of the lamp holder (2) to shield the lamp body (5); the lamp cover (7) is of a transparent or non-transparent style made of glass or engineering plastic for increasing the aesthetic and practical properties.

In summation of the abovementioned, the present invention has the following advantages:

The lamp body of the present invention is assembled as a three-dimensional shape by one or more than one soft circuit board, or by a plurality of rigid circuit boards; a plurality of LEDs are disposed on the outer lateral plane of the circuit board to generate a light source emitting toward multi-directions thereby providing an extensive or specially oriented light source; furthermore, the present invention used the LED as a luminous body so as to save the electricity, have a longer useful life and lower heat as well as to consume less amount of electricity.

The structure and function of the present invention of a light emitting diode light bulb is practical and innovative. It is of course to be understood that the embodiment described herein is merely illustrative of the principles of the invention and that a wide variety of modifications thereto may be effected by persons skilled in the art without departing from the spirit and scope of the invention as set forth in the following claims.

1. A light emitting diode (LED) light bulb comprises a lamp holder and a lamp body; wherein the lamp body is disposed on the top plane of the lamp holder; the present invention is characterized that:
the lamp body is of a multi-directional and three-dimensional shape composed by more than two circuit boards; a plurality of LED light bulbs are disposed in parallel or in tandem on each circuit board to achieve the objective of enabling the light source of the light bulb to emit extensively toward all the directions.

2. The light emitting diode light bulb according to claim 1, wherein the circuit board in the lamp body is made of a soft circuit board so as to allow the lamp body to be bent to form a three-dimensional shape with curved planes.

3. The light emitting diode light bulb according to claim 1, wherein a lamp cover is disposed on the outside of the lamp body.
